(19) United States
(12) Patent Application Publication
(10) Pub. No.: US 2026/0020945 A1
(43) Pub. Date: Jan. 22, 2026

(54) FLOSSING ASSEMBLY

(71) Applicant: Thomas LaGree, Alpharetta, GA (US)

(72) Inventor: Thomas LaGree, Alpharetta, GA (US)

(21) Appl. No.: 19/270,884

(22) Filed: Jul. 16, 2025

Related U.S. Application Data
(60) Provisional application No. 63/672,907, filed on Jul. 18, 2024.

(51) Int. Cl. A61C 15/04

(52) U.S. Cl. CPC A61C 15/046

(57) ABSTRACT

A flossing assembly including a mouthpiece, including an inner wall, an outer wall radially spaced apart from the inner wall, a bottom wall, a channel formed between the inner wall, the outer wall, and the bottom wall, and a top surface including a plurality of slots, and dental floss engaged with the plurality of slots, the dental floss arranged to form a plurality of floss segments that traverse the channel.

### CROSS-REFERENCE TO RELATED APPLICATIONS

This application claims the benefit under 35 U.S.C. § 119 (e) of U.S. Provisional Application No. 63/672,907, filed Jul. 18, 2024, which application is incorporated herein by reference in its entirety.

### FIELD

The present disclosure relates to flossing devices, and more particularly, to a flossing device including a plurality of filaments arranged to floss multiple teeth at the same time, and even more particularly, to a flossing device including a plurality of filaments arranged to floss all teeth at the same time.

### BACKGROUND

Dental floss and tape is a cord of thin filaments used in interdental cleaning to remove food and dental plaque from between teeth (i.e., the spaces between adjacent teeth) or places a toothbrush has difficulty reaching or is unable to reach. Its regular use as part of oral cleaning is intended to maintain oral health. Use of floss is recommended to prevent gingivitis and the build-up of plaque. The American Dental Association claims that up to 80% of plaque can be removed by flossing, and it may confer a particular benefit in individuals with orthodontic devices.

However, current flossing devices only allow for cleaning a single space between two adjacent teeth at a time. This results in a lengthy flossing process, and ultimately many patients or users choosing not to floss.

### SUMMARY

The present disclosure is directed to one or more exemplary embodiments of a flossing assembly.

In an exemplary embodiment, the flossing assembly comprises a mouthpiece, including an inner wall, an outer wall radially spaced apart from the inner wall, a bottom wall, a channel formed between the inner wall, the outer wall, and the bottom wall, and a top surface comprising a plurality of slots, and dental floss engaged with the plurality of slots, the dental floss arranged to form a plurality of floss segments that traverse the channel.

In an exemplary embodiment, the plurality of floss segments are spaced apart in a circumferential direction. In an exemplary embodiment, the dental floss comprises a first end and a second end, the channel comprises a third end and a fourth end, the first end is connected to one of the inner wall and the outer wall at the third end, and the second end is connected to one of the inner wall and the outer wall at the fourth end. In an exemplary embodiment, at least one of the first end and the second end is fixedly secured to the mouthpiece. In an exemplary embodiment, the dental floss is secured to the mouthpiece via adhesive.

In an exemplary embodiment, the channel comprises a width, and the width is constant in a circumferential direction. In an exemplary embodiment, the channel comprises a width, and the width is non-constant in a circumferential direction. In an exemplary embodiment, the mouthpiece further comprises one or more holes extending axially through the bottom wall. In an exemplary embodiment, the mouthpiece further comprises one or more holes extending axially through the bottom wall into the channel. In an exemplary embodiment, the flossing assembly further comprises a tab connected to the mouthpiece. In an exemplary embodiment, the tab extends radially outward from the outer wall.

In an exemplary embodiment, the mouthpiece further comprises a plurality of protrusions extending radially at the top surface, and the dental floss is engaged with the plurality of protrusions. In an exemplary embodiment, the plurality of protrusions comprises a first plurality of protrusions extending radially outward from the outer wall, and a second plurality of protrusions extending radially inward from the inner wall. In an exemplary embodiment, the plurality of protrusions are circumferentially arranged between the plurality of slots. In an exemplary embodiment, the dental floss is further engaged with a radially inward facing surface of the inner wall and a radially outward facing surface of the outer wall. In an exemplary embodiment, the dental floss is further engaged with the bottom wall.

In an exemplary embodiment, the flossing assembly the mouthpiece further comprises a groove extending circumferentially in at least one of the inner wall, the outer wall, and the bottom wall, and the dental floss is engaged with the groove. In an exemplary embodiment, the inner wall comprises a first groove extending in a circumferential direction therein, the outer wall comprises a second groove extending in a circumferential direction therein, and the dental floss is engaged with the first groove and the second groove.

The present disclosure is directed to one or more exemplary embodiments of a flossing assembly.

In an exemplary embodiment, the flossing assembly comprises a mouthpiece, including an inner wall including a radially inward facing surface, an outer wall radially spaced apart from the inner wall and comprising a radially outward facing surface, a bottom wall, a channel formed between the inner wall, the outer wall, and the bottom wall, and a top surface comprising a plurality of slots, the slots extending radially through the inner wall and the outer wall, and dental floss engaged with the plurality of slots and forming a plurality of floss segments that traverse the channel, the dental floss further engaged with the radially inward facing surface and the radially outward facing surface.

In an exemplary embodiment, the mouthpiece further comprises a plurality of protrusions extending radially at the top surface, and the dental floss is engaged with the plurality of protrusions. In an exemplary embodiment, the plurality of slots prevent displacement of the dental floss in a first axial direction, and the plurality of protrusions prevent displacement of the dental floss in a second axial direction, opposite the first axial direction. In an exemplary embodiment, the plurality of protrusions comprises a first plurality of protrusions extending radially outward from the outer wall, and a second plurality of protrusions extending radially inward from the inner wall.

The present disclosure is directed to one or more exemplary embodiments of a flossing assembly.

In an exemplary embodiment, the flossing assembly comprises a mouthpiece, including a first radially inward facing surface, a first radially outward facing surface, a top surface comprising a plurality of circumferentially spaced slots, and a bottom surface, and a plurality of floss units, each floss unit including a bottom portion arranged to be removably connected to the slots, a top surface, a second radially inward facing surface, a second radially outward facing surface, a channel, and dental floss traversing the channel.

According to aspects illustrated herein, there is provided a flossing assembly operatively arranged to floss an entire arch of teeth simultaneously in a very short amount of time (e.g., three seconds). In an exemplary embodiment, the flossing assembly is custom made to allow the patient to floss the entirety of the maxillary arch and the mandibular arch (i.e., using a custom flossing assembly for each arch). The flossing assembly includes a handle or tab, which allows the mouth piece to be displaced in two lateral shifts and two vertical shifts to ensure that the proper technique of the “C” shaped floss method can be performed (i.e., to clean the entire embrasure space).

In an exemplary embodiment, an accurate representation of the patient's dentition and contact points, embrasure depth, gingival recession, variations in occlusal discrepancies is received. The representation could be obtained via an intra oral scan at a dental office, or a mold can be sent to them wherein the patient bites into the mold (similar to a sport mouthguard) returns it. The representation is used to fabricate the flossing assembly mechanism to floss all teeth in one arch based on the angulation of their embrasure space (i.e., space formed by two adjacent teeth). The embrasure space depends on cervical length (i.e., how tall the tooth is from top to bottom) and width (i.e., based on the mesial and distal aspects of the tooth).

In an exemplary embodiment, the flossing assembly comprises holes integrated throughout the mouthpiece that will aid in cleaning and improve overall hygiene resulting in increased mouthguard longevity. In an exemplary embodiment, the flossing assembly further comprises a locking mechanism that allows for proper tension and ease of replacement of the floss. In an exemplary embodiment, the flossing assembly may help reduce plastic waste and/or may be recyclable.

These and other objects, features, and advantages of the present disclosure will become readily apparent upon a review of the following detailed description of the disclosure, in view of the drawings and appended claims.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure, in which corresponding reference symbols indicate corresponding parts. However, the drawings do not illustrate all possible implementations of the presently disclosed subject matter and are not intended to limit the scope of the present disclosure in any way.

FIG. 1A is a front top perspective view of a flossing assembly engaged with teeth.

FIG. 1B is a side perspective view of a flossing assembly engaged with teeth.

FIG. 2A is a top perspective view of a flossing assembly.

FIG. 2B is a bottom perspective view of the flossing assembly shown in FIG. 2A.

FIG. 3A is a top perspective view of a flossing assembly.

FIG. 3B is a bottom perspective view of the flossing assembly shown in FIG. 3A.

FIG. 4 is a top perspective view of a flossing assembly.

FIG. 5A is a top rear perspective view of a flossing assembly.

FIG. 5B is a bottom rear perspective view of the flossing assembly shown in FIG. 5A.

FIG. 5C is a top plan view of the flossing assembly shown in FIG. 5A.

FIG. 5D is a rear elevational view of the flossing assembly shown in FIG. 5A.

FIG. 5E is a side elevational view of the flossing assembly shown in FIG. 5A.

FIG. 6A is a top rear perspective view of a flossing assembly.

FIG. 6B is a bottom front perspective view of the flossing assembly shown in FIG. 6A.

FIG. 6C is a top plan view of the flossing assembly shown in FIG. 6A.

FIG. 6D is a rear elevational view of the flossing assembly shown in FIG. 6A.

FIG. 6E is a side elevational view of the flossing assembly shown in FIG. 6A.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

Where used herein, the terms “first,” “second,” and so on, do not necessarily denote any ordinal, sequential, or priority relation, but are simply used to more clearly distinguish one element or set of elements from another, unless specified otherwise.

Where used herein, the term “about” when applied to a value is intended to mean within the tolerance range of the equipment used to produce the value, or, in some examples, is intended to mean plus or minus 10%, or plus or minus 5%, or plus or minus 1%, unless otherwise expressly specified.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “substantially” is intended to mean values within ten percent of the specified value.

Where used herein, the term “exemplary” is intended to mean “an example of,” “serving as an example,” or “illustrative,” and does not denote any preference or requirement with respect to a disclosed aspect or embodiment.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element. A similar interpretation is intended when the phrase “used in at least one of:” is used herein.

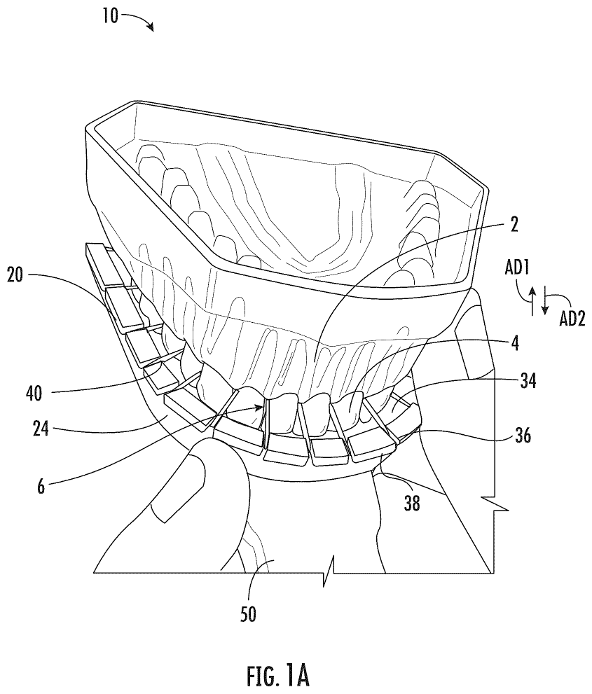

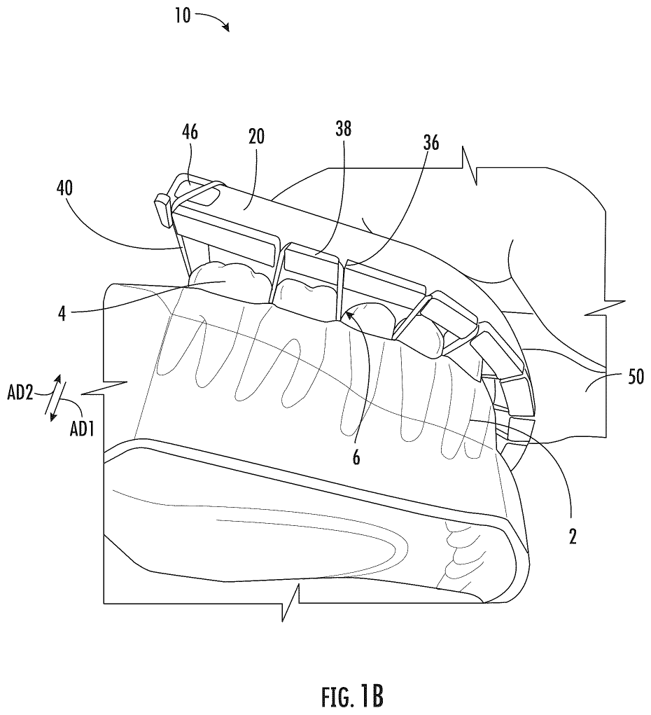

Referring now to the figures, FIG. 1A is a front top perspective view of flossing assembly 10 engaged with teeth 4. FIG. 1B is a side perspective view of flossing assembly 10 engaged with teeth 4. As shown, teeth 4 extend in an axial direction from labial frenulum 2 (i.e., superior or inferior labial frenulum). Spaces 6 are formed between adjacent teeth 4. In an exemplary embodiment, the flossing assembly comprises first flossing apparatus 10, 110, 210, 310, 410 for engagement with maxillary teeth and second flossing apparatus 10, 110, 210, 310, 410 for engagement with mandibular teeth.

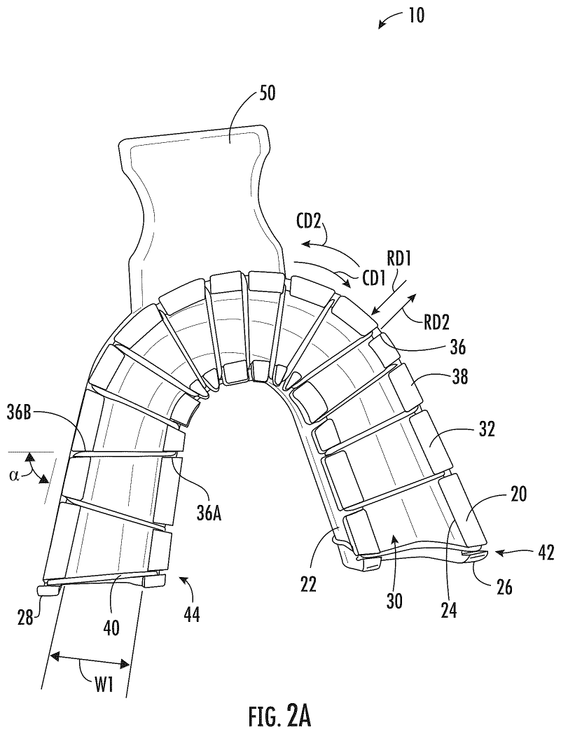

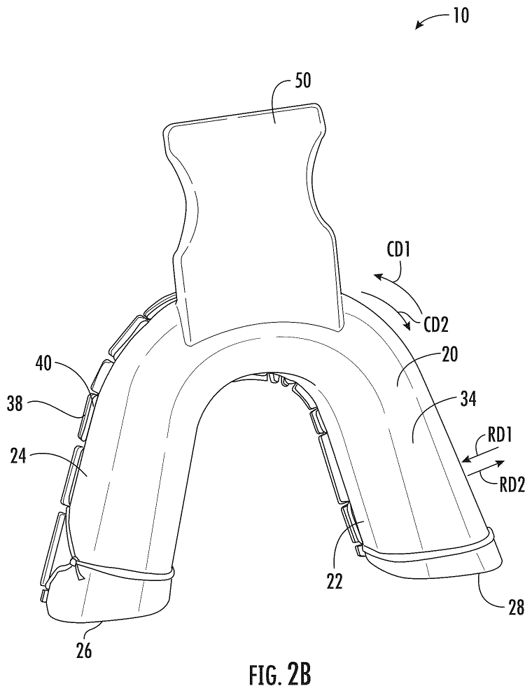

FIG. 2A is a top perspective view of flossing assembly 10. FIG. 2B is a bottom perspective view of flossing assembly 10. Flossing assembly 10 generally comprises mouthpiece 20 and dental floss or tape or cord or filament 40. In an exemplary embodiment, flossing assembly 10 further comprises tab or handle 50.

Mouthpiece 20 comprises inner wall 22, outer wall 24, end 26, end 28, top surface 32, and bottom wall or surface 34. Inner wall 22 and outer wall 24 are radial walls spaced apart radially to form channel 30. In an exemplary embodiment, inner wall 22 is arranged radially inward, for example in radial direction RD1, with respect to outer wall 24. Channel 30 comprises width W1. In an exemplary embodiment, width W1 is constant from end 26 to end 28 in circumferential direction CD2. In an exemplary embodiment, width W1 is constant from end 26 to end 28 in circumferential direction CD2. Inner wall 22 comprises a radially inward facing surface and a radially outward facing surface. Outer wall 24 comprises a radially inward facing surface and a radially outward facing surface. The radially outward facing surface of inner wall 22 and the radially inward facing surface of outer wall 24 form the radial sides of channel 30. In an exemplary embodiment, mouthpiece 20 is generally curvilinear, for example, U-shaped, and resembles the plan view curvature of a user's teeth.

Mouthpiece 20 further comprises a plurality of slots or holes or grooves 36. Slots 36 are arranged in top surface 32 and extend in axial direction AD2 therefrom. Slots 36 also extend in a radial direction through both inner wall 22 and outer wall 24, forming a path through which floss 40 is guided. Corresponding slots 36, which is a slot in inner wall 22 and a slot in outer wall 24 directly connected via floss 40, are formed such that floss 40 is arranged at an optimal angle to engage a user's teeth 4. For example, and as best shown in FIG. 2A, slot 36A in inner wall 22 and slot 36B in outer wall 24 are arranged such that the portion of floss 40 extending therebetween forms angle α with respect to outer wall 24. In an exemplary embodiment, the dimensions of channel 30 and the arrangement of slots 36 are custom designed for a specific user.

Floss 40 is fed through slots 36, traversing channel 30, and secured to mouthpiece 20. In an exemplary embodiment, a single piece of floss 40 having ends 42 and 44 is weaved through slots 36 in a zig-zag arrangement. For example, end 42 is secured to outer wall 24 (or inner wall) via securing means or adhesive 46 at or proximate to end 26. Floss 40 is fed through corresponding slots 36 in radial direction RD1, wrapped around the radially inward facing surface of inner wall 22, and fed through the circumferentially adjacent set of corresponding slots 36 in radial direction RD1. Floss 40 is then wrapped around the radially outward facing surface of outer wall 24, and fed through the circumferentially adjacent set of corresponding slots 36 in radial direction RD1. This process is repeated until end 28 is reached, at which point end 44 of floss 40 is secured to inner wall 22 (or outer wall 24).

In an exemplary embodiment, mouthpiece 20 further comprises one or more protrusions 38. As shown, protrusions 38 are arranged at top surface 32 and extend radially therefrom. For example, inner wall 22 comprises protrusions 38 that extend radially inward in radial direction RD1 at top surface 32. Outer wall 24 comprises protrusions 38 that extend radially outward in radial direction RD2 at top surface 32. Protrusions 38 are arranged circumferentially between slots 36 to prevent floss 40 from being removed from mouthpiece 20 (i.e., in axial direction AD1. Put another way, protrusions 38 maintain floss 40 on mouthpiece 20 such that protrusions 38 prevent displacement of floss 40 in axial direction AD1 and the bottoms of slots 36 prevent displacement of floss 40 in axial direction AD2. It should be appreciated that, in an exemplary embodiment, adhesive may be used instead of or in addition to protrusions 38 to maintain floss 40 on mouthpiece 20.

Tab 50 is fixedly secured to mouthpiece 20 and allows a user to more easily insert mouthpiece 20 into, and remove mouthpiece 20 from, the mouth. Additionally, once mouthpiece 20 is engaged with teeth 4, tab 50 allows the user to displace mouthpiece 20, for example in axial directions AD1-AD2, radial directions RD1-RD2, and circumferential directions CD1-CD2 such that floss 40 may engage all areas of spaces 6 between teeth 4. In an exemplary embodiment, tab 50 is connected to outer wall 24. In an exemplary embodiment, tab 50 is connected to outer wall 24 at or proximate to bottom surface 34. In an exemplary embodiment, tab 50 comprises one or more grip features, for example, recesses, protrusions, knurl, etc.

To use, a user inserts flossing assembly 10 with top surface 38 or channel 30 directed toward teeth 4. Thus, if flossing maxillary teeth 4, top surface 38 should be directed elevationally upward. If flossing mandibular teeth 4, top surface 38 should be directed elevationally downward. It should be appreciated that in an exemplary embodiment, two flossing assemblies 10 are used simultaneously to floss both mandibular and maxillary teeth 4. Floss segments, namely, the portions of floss 40 that traverse channel 30, are aligned with spaces 6. Flossing assembly 10 is displaced in axial direction AD1 with respect to teeth 4 such that floss 40 engages spaces 6. Flossing assembly 10 may then be displaced, for example via tab 50, in axial directions AD1-AD2, radial directions RD1-RD2, and circumferential directions CD1-CD2 such that floss 40 may engage all areas of spaces 6 between teeth 4. Flossing assembly 10 is then displaced in axial direction AD2 to disengage floss 40 from spaces 6, at which point flossing assembly 10 may be removed from the user's mouth. It should be appreciated that flossing assembly 10 is arranged such that floss 40 may be removed after one or more uses, and new floss 40 can be assembled to mouthpiece 20.

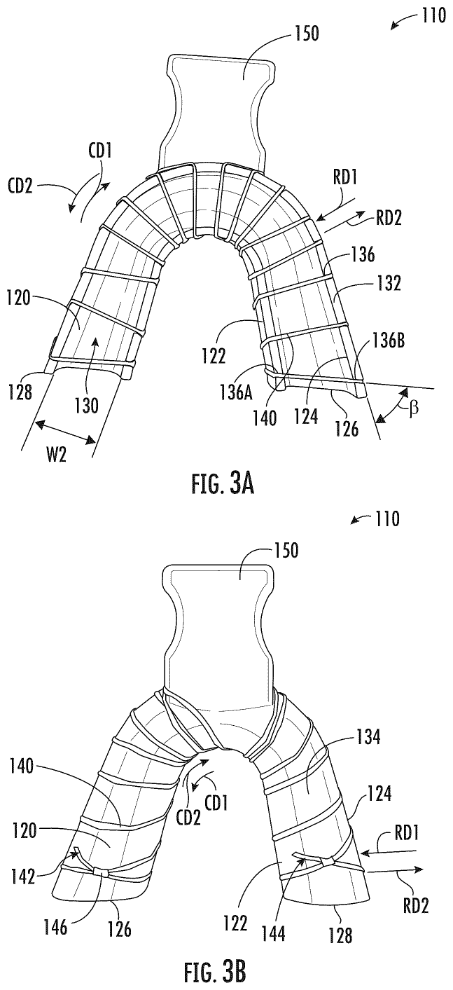

FIG. 3A is a top perspective view of flossing assembly 110. FIG. 3B is a bottom perspective view of flossing assembly 110. Flossing assembly 110 generally comprises mouthpiece 120 and dental floss or tape or cord or filament 140. In an exemplary embodiment, flossing assembly 110 further comprises tab or handle 150.

Mouthpiece 120 comprises inner wall 122, outer wall 124, end 126, end 128, top surface 132, and bottom wall or surface 134. Inner wall 122 and outer wall 124 are radial walls spaced apart radially to form channel 130. In an exemplary embodiment, inner wall 122 is arranged radially inward, for example in radial direction RD1, with respect to outer wall 124. Channel 130 comprises width W2. In an exemplary embodiment, width W2 is constant from end 126 to end 128 in circumferential direction CD2. In an exemplary embodiment, width W2 is constant from end 126 to end 128 in circumferential direction CD2. Inner wall 122 comprises a radially inward facing surface and a radially outward facing surface. Outer wall 124 comprises a radially inward facing surface and a radially outward facing surface. The radially outward facing surface of inner wall 122 and the radially inward facing surface of outer wall 124 form the radial sides of channel 130. In an exemplary embodiment, mouthpiece 120 is generally curvilinear, for example, U-shaped, and resembles the plan view curvature of a user's teeth.

Mouthpiece 120 further comprises a plurality of slots or holes or grooves 136. Slots 136 are arranged in top surface 132 and extend in axial direction AD2 therefrom. Slots 136 also extend in a radial direction through both inner wall 122 and outer wall 124, forming a path through which floss 140 is guided. Corresponding slots 136, which is a slot in inner wall 122 and a slot in outer wall 124 directly connected via floss 140, are formed such that floss 140 is arranged at an optimal angle to engage a user's teeth 4. For example, and as best shown in FIG. 3A, slot 136A in inner wall 122 and slot 136B in outer wall 124 are arranged such that the portion of floss 140 extending therebetween forms angle β with respect to outer wall 124. In an exemplary embodiment, the dimensions of channel 130 and the arrangement of slots 136 are custom designed for a specific user.

Floss 140 is fed through slots 136, traversing channel 130, and secured to mouthpiece 120. In an exemplary embodiment, a single piece of floss 140 having ends 142 and 144 is wrapped around mouthpiece 120 and engaged with slots 136. For example, end 142 is secured to bottom surface 134 (or outer wall 124 or inner 122 wall) via securing means or adhesive 146 at or proximate to end 126. Floss 140 is wrapped up around top surface 132 and fed through corresponding slots 136 in radial direction RD1. Floss 140 is then wrapped down around bottom surface 134 and back up around top surface 132, where it is fed through the circumferentially adjacent set of corresponding slots 136. This process is repeated until end 128 is reached, at which point end 144 of floss 140 is secured to bottom surface 134 (or inner wall 122 or outer wall 24), for example via adhesive 146. In an exemplary embodiment, adhesive 146 is applied at one or more portions where floss 140 engages inner wall 122 and/or outer wall 124 to maintain floss 140 on mouthpiece 120. For example, at one or more locations where floss 140 is wrapped around the radially inward facing surface of inner wall 122 and the radially outward facing surface of outer wall 124, adhesive 146 may be applied.

Tab 150 is fixedly secured to mouthpiece 120 and allows a user to more easily insert mouthpiece 120 into, and remove mouthpiece 120 from, the mouth. Additionally, once mouthpiece 120 is engaged with teeth 4, tab 150 allows the user to displace mouthpiece 120, for example in axial directions AD1-AD2, radial directions RD1-RD2, and circumferential directions CD1-CD2 such that floss 140 may engage all areas of spaces 6 between teeth 4. In an exemplary embodiment, tab 150 is connected to outer wall 124. In an exemplary embodiment, tab 150 is connected to outer wall 124 at or proximate to bottom surface 134. In an exemplary embodiment, tab 150 comprises one or more grip features, for example, recesses, protrusions, knurl, etc.

To use, a user inserts flossing assembly 110 with top surface 138 or channel 130 directed toward teeth 4. Thus, if flossing maxillary teeth 4, top surface 138 should be directed elevationally upward. If flossing mandibular teeth 4, top surface 138 should be directed elevationally downward. It should be appreciated that in an exemplary embodiment, two flossing assemblies 110 are used simultaneously to floss both mandibular and maxillary teeth 4. Floss segments, namely, the portions of floss 140 that traverse channel 130, are aligned with spaces 6. Flossing assembly 110 is displaced in axial direction AD1 with respect to teeth 4 such that floss 140 engages spaces 6. Flossing assembly 110 may then be displaced, for example via tab 150, in axial directions AD1-AD2, radial directions RD1-RD2, and circumferential directions CD1-CD2 such that floss 140 may engage all areas of spaces 6 between teeth 4. Flossing assembly 110 is then displaced in axial direction AD2 to disengage floss 140 from spaces 6, at which point flossing assembly 110 may be removed from the user's mouth. It should be appreciated that flossing assembly 110 is arranged such that floss 140 may be removed after one or more uses, and new floss 140 can be assembled to mouthpiece 120.

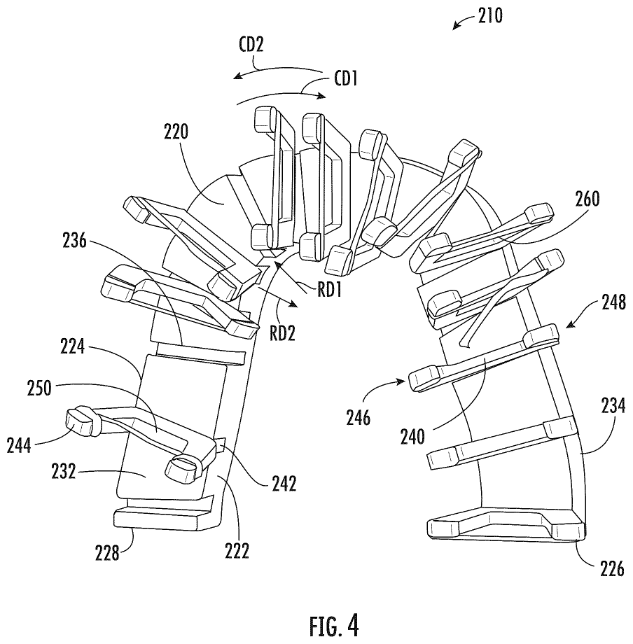

FIG. 4 is a top perspective view of flossing assembly 210. Flossing assembly 210 generally comprises mouthpiece 220 and a plurality of floss units 240 removably connected thereto. In an exemplary embodiment, flossing assembly 210 further comprises a tab or handle (not shown).

Mouthpiece 220 comprises radially inward facing surface 222, radially outward facing surface 224, end 226, end 228, top surface 232, and bottom wall or surface 234. Mouthpiece 220 further comprises a plurality of slots or holes or grooves 236. Slots 236 are arranged in top surface 232 and extend in axial direction AD2 therefrom. Slots 236 also extend in a radial direction from radially outward facing surface 224 to radially inward facing surface 222. Slots 236 are operatively arranged to engage slot units 240 and are formed such that dental floss or tape or cord or filament 260 is arranged at an optimal angle to engage a user's teeth 4. In an exemplary embodiment, the dimensions of mouthpiece 220 and the arrangement of slots 236 are custom designed for a specific user. In an exemplary embodiment, mouthpiece 220 is generally curvilinear, for example, U-shaped, and resembles the plan view curvature of a user's teeth.

Each floss unit 240 comprises bottom surface 242, top surface 224, radially inward facing surface 246, radially outward facing surface 248, and channel 250. Channel 250 is arranged in top surface 244 and extends in axial direction AD2 therefrom. Channel 250 is arranged radially between and spaced apart from radially inward facing surface 246 and radially outward facing surface 248. In an exemplary embodiment, channel 250 forms two arms to which floss 260 is connected. Floss 260 traverses channel 250 and is secured to each arm via any suitable means, for example, tying, adhesives, clips, etc.

Floss units 240 are removably connected to mouthpiece 220 via slots 236. For example, bottom portion 242 may comprise one of a protrusion and groove and slots 236 may comprise the other of a protrusion and groove. In such example, floss units 240 may be slid radially into slots 236 and the engagement of the respective groove and protrusion prevents floss units 240 from being removed axially from mouthpiece 220. Thus, floss units 240 are easily replaceable after a predetermined number of uses.

To use, a user inserts flossing assembly 210 with top surface 232 or channel 250 directed toward teeth 4. Thus, if flossing maxillary teeth 4, channel 250 should be directed elevationally upward. If flossing mandibular teeth 4, channel 250 should be directed elevationally downward. It should be appreciated that in an exemplary embodiment, two flossing assemblies 210 are used simultaneously to floss both mandibular and maxillary teeth 4. Floss segments, namely, the portions of floss 260 that traverse channels 250, are aligned with spaces 6. Flossing assembly 210 is displaced in axial direction AD1 with respect to teeth 4 such that floss 260 engages spaces 6. Flossing assembly 210 may then be displaced, for example via a tab (not shown), in axial directions AD1-AD2, radial directions RD1-RD2, and circumferential directions CD1-CD2 such that floss 260 may engage all areas of spaces 6 between teeth 4. Flossing assembly 210 is then displaced in axial direction AD2 to disengage floss 240 from spaces 6, at which point flossing assembly 210 may be removed from the user's mouth. It should be appreciated that flossing assembly 210 is arranged such that floss units 240 may be removed after one or more uses, and new floss units 240 can be assembled to mouthpiece 220.

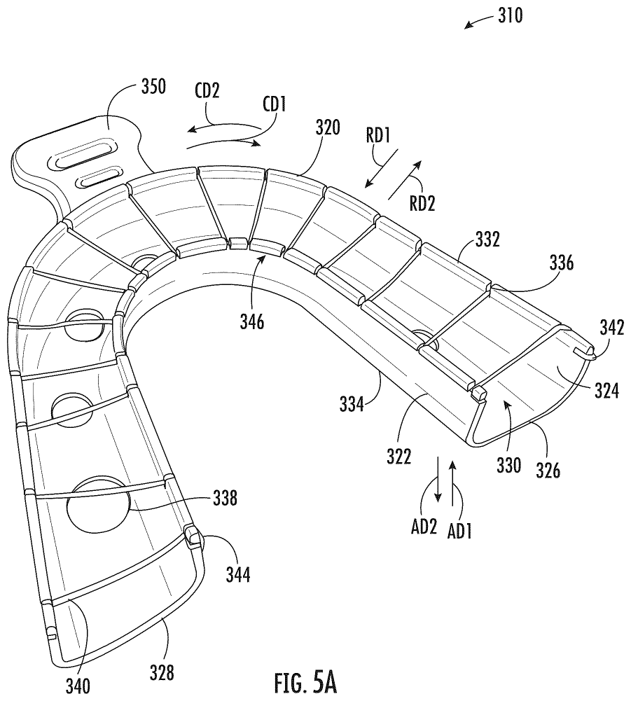

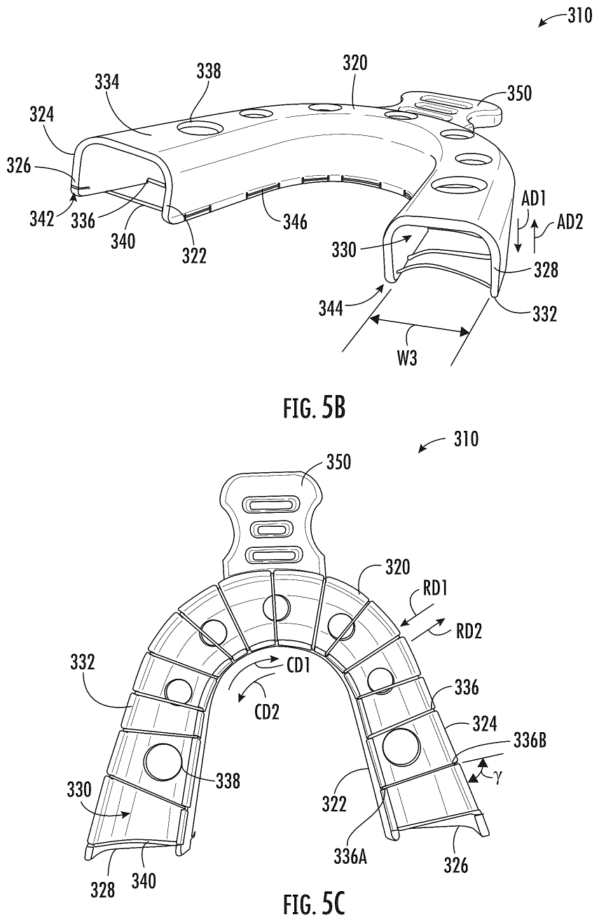

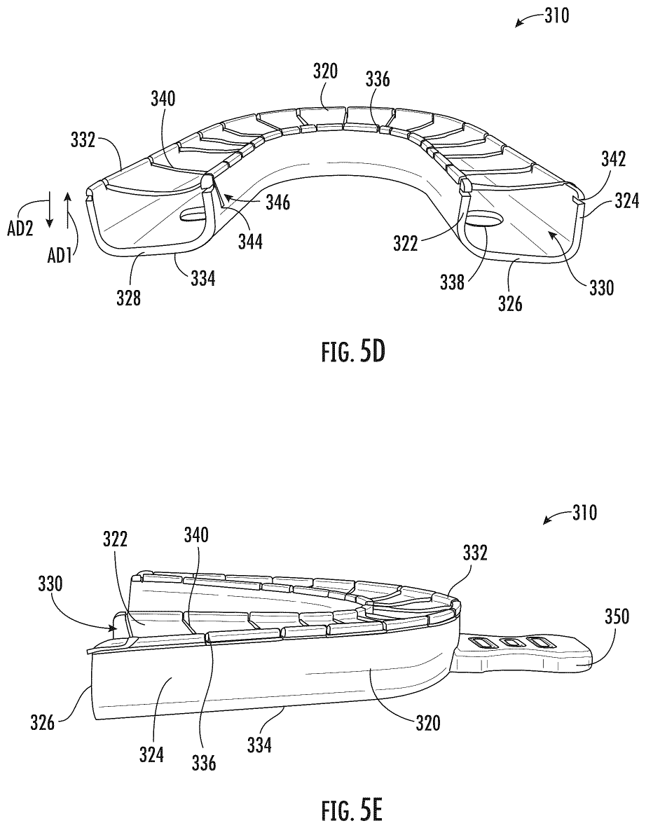

FIG. 5A is a top rear perspective view of flossing assembly 310. FIG. 5B is a bottom rear perspective view of flossing assembly 310. FIG. 5C is a top plan view of flossing assembly 310. FIG. 5D is a rear elevational view of flossing assembly 310. FIG. 5E is a side elevational view of flossing assembly 310. Flossing assembly 310 generally comprises mouthpiece 320 and dental floss or tape or cord or filament 340. In an exemplary embodiment, flossing assembly 310 further comprises tab or handle 350.

Mouthpiece 320 comprises inner wall 322, outer wall 324, end 326, end 328, top surface 332, and bottom wall or surface 334. Inner wall 322 and outer wall 324 are radial walls spaced apart radially to form channel 330. In an exemplary embodiment, inner wall 322 is arranged radially inward, for example in radial direction RD1, with respect to outer wall 324. Channel 330 comprises width W3. In an exemplary embodiment, width W3 is constant from end 326 to end 328 in circumferential direction CD2. In an exemplary embodiment, width W3 is not constant from end 326 to end 328 in circumferential direction CD2. Inner wall 322 comprises a radially inward facing surface and a radially outward facing surface. Outer wall 324 comprises a radially inward facing surface and a radially outward facing surface. The radially outward facing surface of inner wall 322 and the radially inward facing surface of outer wall 324 form the radial sides of channel 330. In an exemplary embodiment, mouthpiece 320 is generally curvilinear, for example, U-shaped, and resembles the plan view curvature of a user's teeth.

Mouthpiece 320 further comprises a plurality of slots or holes or grooves 336. Slots 336 are arranged in top surface 332 and extend in axial direction AD2 therefrom. Slots 336 also extend in a radial direction through both inner wall 322 and outer wall 324, forming a path through which floss 340 is guided. Corresponding slots 336, which is a slot in inner wall 322 and a slot in outer wall 324 directly connected via floss 340, are formed such that floss 340 is arranged at an optimal angle to engage a user's teeth 4. For example, and as best shown in FIG. 5C, slot 336A in inner wall 322 and slot 336B in outer wall 324 are arranged such that the portion of floss 340 extending therebetween forms angle γ with respect to outer wall 324. In an exemplary embodiment, the dimensions of channel 330 and the arrangement of slots 336 are custom designed for a specific user.

In an exemplary embodiment, mouthpiece 320 further comprises one or more through-holes 338. Through-holes 338 extend in axial direction AD1 from bottom surface 334 to channel 330. Through-holes 338 allow for better cleaning of mouthpiece 320, allowing more of channel 330 to be accessible with floss 340 arranged thereon. Through-holes 338 also provide a means for draining of cleaning materials as well as airflow for drying purposes. In an exemplary embodiment, all through-holes 338 are equal in dimension and shape. In an exemplary embodiment, at least two through-holes 338 differ in dimension and/or shape.

Floss 340 is fed through slots 336, traversing channel 330, and secured to mouthpiece 320. In an exemplary embodiment, a single piece of floss 340 having ends 342 and 344 is weaved through slots 336 in a zig-zag arrangement. For example, end 342 is secured to outer wall 324 (or inner wall) via securing means or adhesive 346 at or proximate to end 326. Floss 340 is fed through corresponding slots 336 in radial direction RD1, wrapped around the radially inward facing surface of inner wall 322, and fed through the circumferentially adjacent set of corresponding slots 336 in radial direction RD2. Floss 340 is then wrapped around the radially outward facing surface of outer wall 324, and fed through the circumferentially adjacent set of corresponding slots 336 in radial direction RD1. This process is repeated until end 328 is reached, at which point end 344 of floss 340 is secured to inner wall 322 (or outer wall 24). In an exemplary embodiment, adhesive 346 is applied at one or more portions where floss 340 engages inner wall 322 and/or outer wall 324 to maintain floss 340 on mouthpiece 320. For example, at one or more locations where floss 340 is wrapped around the radially inward facing surface of inner wall 322 and the radially outward facing surface of outer wall 324, adhesive 346 may be applied.

Tab 350 is fixedly secured to mouthpiece 320 and allows a user to more easily insert mouthpiece 320 into, and remove mouthpiece 320 from, the mouth. Additionally, once mouthpiece 320 is engaged with teeth 4, tab 350 allows the user to displace mouthpiece 320, for example in axial directions AD1-AD2, radial directions RD1-RD2, and circumferential directions CD1-CD2 such that floss 340 may engage all areas of spaces 6 between teeth 4. In an exemplary embodiment, tab 350 is connected to outer wall 324. In an exemplary embodiment, tab 350 is connected to outer wall 324 at or proximate to bottom surface 334. In an exemplary embodiment, tab 350 comprises one or more grip features, for example, recesses, protrusions, knurl, etc.

To use, a user inserts flossing assembly 310 with top surface 338 or channel 330 directed toward teeth 4. Thus, if flossing maxillary teeth 4, top surface 338 should be directed elevationally upward. If flossing mandibular teeth 4, top surface 338 should be directed elevationally downward. It should be appreciated that in an exemplary embodiment, two flossing assemblies 310 are used simultaneously to floss both mandibular and maxillary teeth 4. Floss segments, namely, the portions of floss 340 that traverse channel 330, are aligned with spaces 6. Flossing assembly 310 is displaced in axial direction AD1 with respect to teeth 4 such that floss 340 engages spaces 6. Flossing assembly 310 may then be displaced, for example via tab 350, in axial directions AD1-AD2, radial directions RD1-RD2, and circumferential directions CD1-CD2 such that floss 340 may engage all areas of spaces 6 between teeth 4. Flossing assembly 310 is then displaced in axial direction AD2 to disengage floss 340 from spaces 6, at which point flossing assembly 310 may be removed from the user's mouth.

It should be appreciated that flossing assembly 310 is arranged such that floss 340 may be removed after one or more uses, and new floss 340 can be assembled to mouthpiece 320. Alternatively, floss 340 may be fixedly secured to mouthpiece 320 and not removable. In such instances flossing assembly 310 may be completely disposable after a predetermined number of uses (e.g., one or more uses).

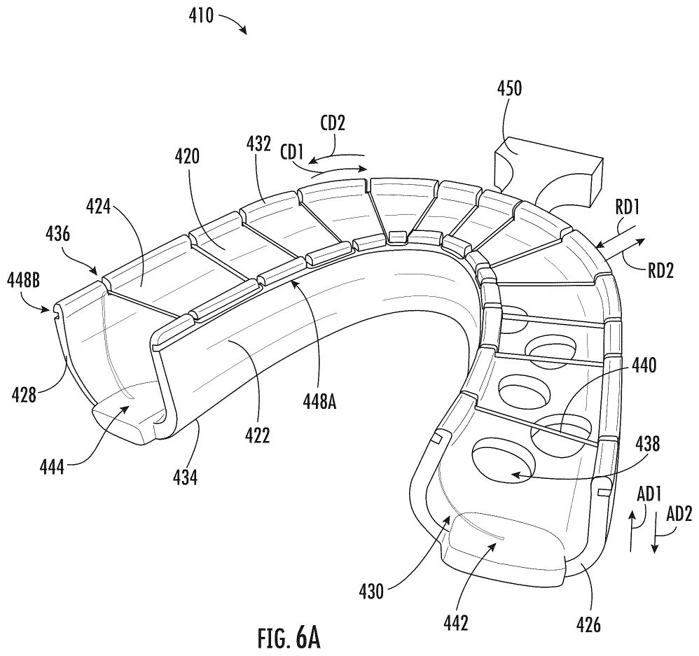

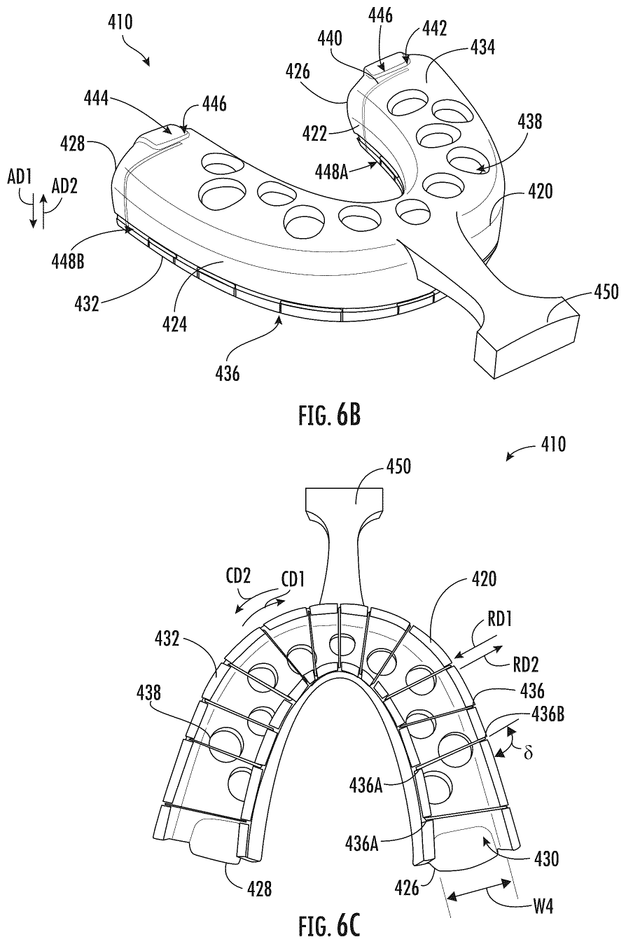

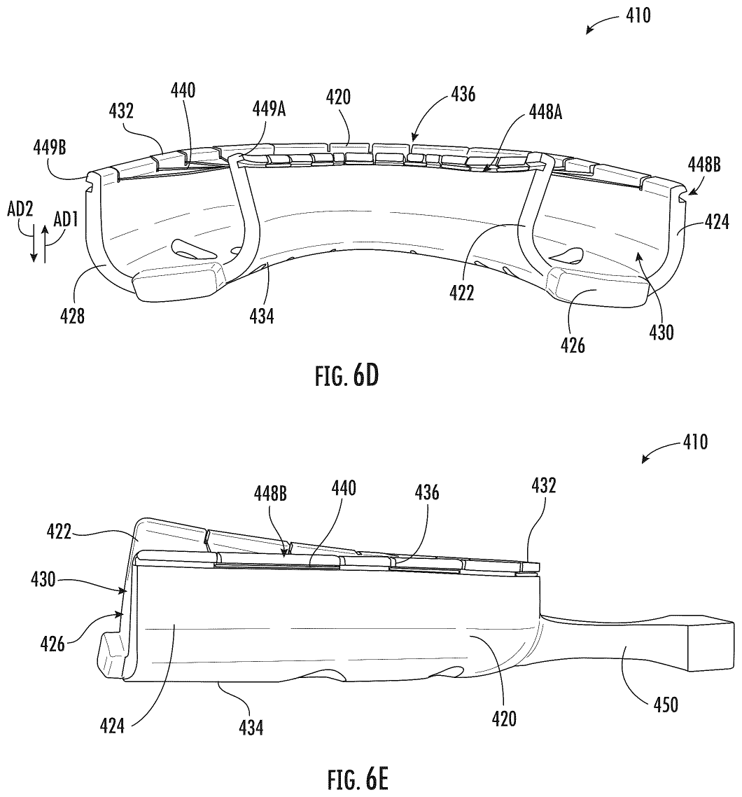

FIG. 6A is a top rear perspective view of flossing assembly 410. FIG. 6B is a bottom front perspective view of flossing assembly 410. FIG. 6C is a top plan view of flossing assembly 410. FIG. 6D is a rear elevational view of flossing assembly 410. FIG. 6E is a side elevational view of flossing assembly 410. Flossing assembly 410 generally comprises mouthpiece 420 and dental floss or tape or cord or filament 440. In an exemplary embodiment, flossing assembly 410 further comprises tab or handle 450.

Mouthpiece 420 comprises inner wall 422, outer wall 424, end 426, end 428, top surface 432, and bottom wall or surface 434. Inner wall 422 and outer wall 424 are radial walls spaced apart radially to form channel 430. In an exemplary embodiment, inner wall 422 is arranged radially inward, for example in radial direction RD1, with respect to outer wall 424. Channel 430 comprises width W4. In an exemplary embodiment, width W4 is constant from end 426 to end 428 in circumferential direction CD2. In an exemplary embodiment, width W4 is not constant from end 426 to end 428 in circumferential direction CD2.

Inner wall 422 comprises a radially inward facing surface and a radially outward facing surface. Outer wall 424 comprises a radially inward facing surface and a radially outward facing surface. The radially outward facing surface of inner wall 422 and the radially inward facing surface of outer wall 424 form the radial sides of channel 430. In an exemplary embodiment, mouthpiece 420 is generally curvilinear, for example, U-shaped, and resembles the plan view curvature of a user's teeth.

The radially inward facing surface of inner wall 422 comprises groove 448A. Groove 448A generally extends in a circumferential direction along inner wall 422. Groove 448A is arranged axially between and spaced apart from top surface 432 and bottom surface 434. Floss 440 is operatively arranged to engage groove 448A to facilitate securement of floss 440 to inner wall 422. In an exemplary embodiment, groove 448A is continuous from end 428 to end 426 in circumferential direction CD2. In an exemplary embodiment, groove 448A is non-continuous, or resembles a dashed line being arranged only where floss 440 engages the radially inward facing surface of inner wall 422. In an exemplary embodiment, groove 448A is parallel to top surface 432. In an exemplary embodiment, groove 448A is non-parallel to top surface 432.

In an exemplary embodiment, in addition to or alternative to groove 448A, inner wall 422 comprises one or more flanges or protrusions 449A extending radially inward therefrom. Floss 440 is operatively arranged to engage protrusion 449A to facilitate securement of floss 440 to inner wall 422. In an exemplary embodiment, protrusion 449A extends radially inward from inner wall 422 at top surface 432. In an exemplary embodiment, protrusion 449A extends radially inward from inner wall 422 at a position axially between and spaced apart from top surface 432 and bottom surface 434.

The radially outward facing surface of outer wall 424 comprises groove 448B. Groove 448B generally extends in a circumferential direction along outer wall 424. Groove 448B is arranged axially between and spaced apart from top surface 432 and bottom surface 434. Floss 440 is operatively arranged to engage groove 448B to facilitate securement of floss 440 to outer wall 424. In an exemplary embodiment, groove 448B is continuous from end 428 to end 426 in circumferential direction CD2. In an exemplary embodiment, groove 448B is non-continuous, or resembles a dashed line being arranged only where floss 440 engages the radially outward facing surface of outer wall 424. In an exemplary embodiment, groove 448B is parallel to top surface 432. In an exemplary embodiment, groove 448B is non-parallel to top surface 432.

In an exemplary embodiment, in addition to or alternative to groove 448B, outer wall 424 comprises one or more flanges or protrusions 449B extending radially outward therefrom. Floss 440 is operatively arranged to engage protrusion 449B to facilitate securement of floss 440 to outer wall 424. In an exemplary embodiment, protrusion 449B extends radially outward from outer wall 424 at top surface 432. In an exemplary embodiment, protrusion 449B extends radially outward from outer wall 424 at a position axially between and spaced apart from top surface 432 and bottom surface 434.

Mouthpiece 420 further comprises a plurality of slots or holes or grooves 436. Slots 436 are arranged in top surface 432 and extend in axial direction AD2 therefrom. Slots 436 also extend in a radial direction through both inner wall 422 and outer wall 424, forming a path through which floss 440 is guided. Corresponding slots 436, which is a slot in inner wall 422 and a slot in outer wall 424 directly connected via floss 440, are formed such that floss 440 is arranged at an optimal angle to engage a user's teeth 4. For example, and as best shown in FIG. 6C, slot 436A in inner wall 422 and slot 436B in outer wall 424 are arranged such that the portion of floss 440 extending therebetween forms angle & with respect to outer wall 424. In an exemplary embodiment, the dimensions of channel 430 and the arrangement of slots 436 are custom designed for a specific user.

In an exemplary embodiment, mouthpiece 420 further comprises one or more through-holes 438. Through-holes 438 extend in axial direction AD1 from bottom surface 434 to channel 430. Through-holes 438 allow for better cleaning of mouthpiece 420, allowing more of channel 430 to be accessible with floss 440 arranged thereon. Through-holes 438 also provide a means for draining of cleaning materials as well as airflow for drying purposes. In an exemplary embodiment, all through-holes 438 are equal in dimension and shape. In an exemplary embodiment, at least two through-holes 438 differ in dimension and/or shape.

Floss 440 is fed through slots 436, traversing channel 430, and secured to mouthpiece 420. In an exemplary embodiment, a single piece of floss 440 having ends 442 and 444 is weaved through slots 436 in a zig-zag arrangement. For example, end 442 is secured to a wall of mouthpiece 420 (e.g., bottom wall 434, inner wall 422, or outer wall 424) via securing means or adhesive 446 at or proximate to end 426. Floss 440 is fed through corresponding slots 436 in radial direction RD2, wrapped around the radially outward facing surface of outer wall 424 and engaged with groove 448B and/or protrusion 449B, and fed through the circumferentially adjacent set of corresponding slots 436 in radial direction RD1. Floss 440 is then wrapped around the radially inward facing surface of inner wall 322, and fed through the circumferentially adjacent set of corresponding slots 436 in radial direction RD2. This process is repeated until end 428 is reached, at which point end 444 of floss 440 is secured to a wall of mouthpiece 420 (e.g., bottom wall 434, inner wall 422, or outer wall 424) via securing means or adhesive 446 at or proximate to end 428.

In an exemplary embodiment, adhesive 446 is applied at one or more portions where floss 440 engages inner wall 422 and/or outer wall 424 to maintain floss 440 on mouthpiece 420. For example, at one or more locations where floss 440 is wrapped around the radially inward facing surface of inner wall 422 and the radially outward facing surface of outer wall 424, adhesive 446 may be applied.

Tab 450 is fixedly secured to mouthpiece 420 and allows a user to more easily insert mouthpiece 420 into, and remove mouthpiece 420 from, the mouth. Additionally, once mouthpiece 420 is engaged with teeth 4, tab 450 allows the user to displace mouthpiece 420, for example in axial directions AD1-AD2, radial directions RD1-RD2, and circumferential directions CD1-CD2 such that floss 440 may engage all areas of spaces 6 between teeth 4. In an exemplary embodiment, tab 450 is connected to outer wall 424. In an exemplary embodiment, tab 450 is connected to outer wall 424 at or proximate to bottom surface 434. In an exemplary embodiment, tab 450 comprises one or more grip features, for example, recesses, protrusions, knurl, etc.

To use, a user inserts flossing assembly 410 with top surface 438 or channel 430 directed toward teeth 4. Thus, if flossing maxillary teeth 4, top surface 438 should be directed elevationally upward. If flossing mandibular teeth 4, top surface 438 should be directed elevationally downward. It should be appreciated that in an exemplary embodiment, two flossing assemblies 410 are used simultaneously to floss both mandibular and maxillary teeth 4. Floss segments, namely, the portions of floss 440 that traverse channel 430, are aligned with spaces 6. Flossing assembly 410 is displaced in axial direction AD1 with respect to teeth 4 such that floss 440 engages spaces 6. Flossing assembly 410 may then be displaced, for example via tab 450, in axial directions AD1-AD2, radial directions RD1-RD2, and circumferential directions CD1-CD2 such that floss 440 may engage all areas of spaces 6 between teeth 4. Flossing assembly 410 is then displaced in axial direction AD2 to disengage floss 440 from spaces 6, at which point flossing assembly 410 may be removed from the user's mouth.

It should be appreciated that flossing assembly 410 is arranged such that floss 440 may be removed after one or more uses, and new floss 440 can be assembled to mouthpiece 420. Alternatively, floss 440 may be fixedly secured to mouthpiece 420 and not removable. In such instances flossing assembly 410 may be completely disposable after a predetermined number of uses (e.g., one or more uses). In an exemplary embodiment, the adhesive mentioned herein is a biocompatible resin such as MED625FLX™ dental resin.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

2 Labial frenulum
4 Teeth
6 Spaces
10 Flossing assembly
20 Mouthpiece
22 Inner wall
24 Outer wall
26 End
28 End
30 Channel
32 Top surface
34 Bottom wall or surface
36 Slots or holes or grooves
36A Slot
36B Slot
38 Protrusions
40 Dental floss or tape or cord or filament
42 End
44 End
46 Securing means or adhesive
50 Tab or handle
110 Flossing assembly
120 Mouthpiece
122 Inner wall
124 Outer wall
126 End
128 End
130 Channel
132 Top surface
134 Bottom wall or surface
136 Slots or holes or grooves
136A Slot
136B Slot
140 Dental floss or tape or cord or filament
142 End
144 End
146 Securing means or adhesive
150 Tab or handle
210 Flossing assembly
220 Mouthpiece
222 Radially inward facing surface
224 Radially outward facing surface
226 End
228 End
232 Top surface
234 Bottom wall or surface
236 Slots or holes or grooves
240 Floss unit
242 Bottom surface
244 Top surface
246 Radially inward facing surface
248 Radially outward facing surface
250 Channel
260 Dental floss or tape or cord or filament
310 Flossing assembly
320 Mouthpiece
322 Inner wall
324 Outer wall
326 End
328 End
330 Channel
332 Top surface
334 Bottom wall or surface
336 Slots or holes or grooves
336A Slot
336B Slot
338 Through-holes
340 Dental floss or tape or cord or filament
342 End
344 End
346 Securing means or adhesive
350 Tab or handle
410 Flossing assembly
420 Mouthpiece
422 Inner wall
424 Outer wall
426 End
428 End
430 Channel
432 Top surface
434 Bottom wall or surface
436 Slots or holes or grooves
436A Slot
436B Slot
438 Through-holes
440 Dental floss or tape or cord or filament
442 End
444 End
446 Securing means or adhesive
448A Groove
448B Groove
449A Protrusion or flange
449B Protrusion or flange
450 Tab or handle
AD1 Axial direction
AD2 Axial direction
CD1 Circumferential direction
CD2 Circumferential direction
RD1 Radial direction
RD2 Radial direction
W1 Width
W2 Width
W3 Width
W4 Width
α Angle
β Angle
γ Angle
δ Angle

What is claimed is:

1. A flossing assembly, comprising:
a mouthpiece, including:
an inner wall;
an outer wall radially spaced apart from the inner wall;
a bottom wall;
a channel formed between the inner wall, the outer wall, and the bottom wall; and
a top surface comprising a plurality of slots; and
dental floss engaged with the plurality of slots, the dental floss arranged to form a plurality of floss segments that traverse the channel.

2. The flossing assembly as recited in claim 1, wherein the plurality of floss segments are spaced apart in a circumferential direction.

3. The flossing assembly as recited in claim 1, wherein:
the dental floss comprises a first end and a second end;
the channel comprises a third end and a fourth end;
the first end is connected to one of the inner wall, the outer wall, and the bottom wall at or proximate to the third end; and
the second end is connected to one of the inner wall, the outer wall, and the bottom wall at or proximate to the fourth end.

4. The flossing assembly as recited in claim 3, wherein at least one of the first end and the second end is fixedly secured to the mouthpiece.

5. The flossing assembly as recited in claim 3, wherein the dental floss is secured to the mouthpiece via adhesive.

6. The flossing assembly as recited in claim 1, wherein the channel comprises a width, and the width is non-constant in a circumferential direction.

7. The flossing assembly as recited in claim 1, wherein the mouthpiece further comprises one or more holes extending axially through the bottom wall.

8. The flossing assembly as recited in claim 1, further comprising a tab connected to the mouthpiece.

9. The flossing assembly as recited in claim 8, wherein the tab extends radially outward from the outer wall.

10. The flossing assembly as recited in claim 1, wherein:
the mouthpiece further comprises a plurality of protrusions extending radially at the top surface; and
the dental floss is engaged with the plurality of protrusions.

11. The flossing assembly as recited in claim 10, wherein the plurality of protrusions comprises:
a first plurality of protrusions extending radially outward from the outer wall; and
a second plurality of protrusions extending radially inward from the inner wall.

12. The flossing assembly as recited in claim 10, wherein the plurality of protrusions are circumferentially arranged between the plurality of slots.

13. The flossing assembly as recited in claim 1, wherein the dental floss is further engaged with a radially inward facing surface of the inner wall and a radially outward facing surface of the outer wall.

14. The flossing assembly as recited in claim 1, wherein:
the mouthpiece further comprises a groove extending circumferentially in at least one of the inner wall, the outer wall, and the bottom wall; and
the dental floss is engaged with the groove.

15. The flossing assembly as recited in claim 1, wherein:
the inner wall comprises a first groove extending in a circumferential direction therein;
the outer wall comprises a second groove extending in a circumferential direction therein; and
the dental floss is engaged with the first groove and the second groove.

16. A flossing assembly, comprising:
a mouthpiece, including:
an inner wall including a radially inward facing surface;
an outer wall radially spaced apart from the inner wall and comprising a radially outward facing surface;
a bottom wall;
a channel formed between the inner wall, the outer wall, and the bottom wall; and
a top surface comprising a plurality of slots, the slots extending radially through the inner wall and the outer wall; and
dental floss engaged with the plurality of slots and forming a plurality of floss segments that traverse the channel, the dental floss further engaged with the radially inward facing surface and the radially outward facing surface.

17. The flossing assembly as recited in claim 16, wherein:
the mouthpiece further comprises a plurality of protrusions extending radially at the top surface; and
the dental floss is engaged with the plurality of protrusions.

18. The flossing assembly as recited in claim 17, wherein:
the plurality of slots prevent displacement of the dental floss in a first axial direction; and
the plurality of protrusions prevent displacement of the dental floss in a second axial direction, opposite the first axial direction.

19. The flossing assembly as recited in claim 17, wherein the plurality of protrusions comprises:
a first plurality of protrusions extending radially outward from the outer wall; and
a second plurality of protrusions extending radially inward from the inner wall.

20. A flossing assembly, comprising:
a mouthpiece, including:
a first radially inward facing surface;
a first radially outward facing surface;
a top surface comprising a plurality of circumferentially spaced slots; and
a bottom surface; and
a plurality of floss units, each floss unit including:
a bottom portion arranged to be removably connected to the slots;
a top surface;
a second radially inward facing surface;
a second radially outward facing surface;
a channel; and
dental floss traversing the channel.
